(19) United States
(12) Patent Application Publication
(10) Pub. No.: US 2026/0264014 A1
(43) Pub. Date: Sep. 10, 2026

(54) SYSTEM AND METHOD FOR TREATING AIR CONTAINING VOLATILE ORGANIC COMPOUNDS (VOCs)

(71) Applicant: Taiwan Semiconductor Manufacturing Company Limited, Hsin-Chu (TW)

(72) Inventors: Chih-Ming TSAO, Miaoli City (TW); Chieh Pu LAI, Taichung City (TW)

(21) Appl. No.: 19/074,621

(22) Filed: Mar. 10, 2025

(51) Int. Cl. B01D 53/94

(52) U.S. Cl. CPC B01D 53/94; B01D 2255/2073; B01D 2255/20738; B01D 2257/708

(57) ABSTRACT

A system and method for treating air containing volatile organic compounds (VOCs). The system includes a concentrator, a thermal incinerator, and a catalytic filtration system. The concentrator removes the VOCs from the air to form treated air and concentrated VOC air. The concentrated VOC air is mixed with fuel to form a fuel/air mixture that is combusted by the thermal incinerator to form incinerator exhaust air, which is cooled to form cooled incinerator exhaust air. In the catalytic filtration system, ozone and/or reactive oxygen species (ROS) are generated and injected into the cooled incinerator exhaust air. Particulate matter is removed from the cooled incinerator exhaust air by one or more filters. Using one or more catalysts, NOx in the cooled incinerator exhaust air containing the ozone and/or ROS is converted into nitrogen oxides of the formula NₓO_{y}, where x and y are each 2 or greater.

### BACKGROUND

Semiconductor devices are formed on, in, and/or from semiconductor wafers, and are used in a multitude of electronic devices, such as mobile phones, laptops, desktops, tablets, watches, gaming systems, and various other industrial, commercial, and consumer electronics. Semiconductor devices are fabricated using various processes within a semiconductor fabrication facility (FAB). Like other industrial processes, the processes in a semiconductor FAB often generate byproducts, such as volatile organic compounds (VOCs), which are removed and/or otherwise treated so as inhibit emissions into the outside environment.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 shows a schematic of a semiconductor fabrication facility (FAB), in accordance with some embodiments;

FIG. 2 shows a schematic of a volatile organic compound (VOC) exhaust treatment system of the semiconductor FAB, in accordance with some embodiments;

FIG. 3 shows a schematic of a radially stratified flame core burner, in accordance with some embodiments;

FIG. 4 shows a schematic of a burner that has surface-stabilized combustion, in accordance with some embodiments;

FIG. 5 shows a schematic of a catalytic filtration system of the VOC exhaust treatment system of FIG. 2, in accordance with some embodiments;

FIG. 6 shows an elevational view of a filter tube of the catalytic filtration system of FIG. 5, in accordance with some embodiments;

FIG. 7 shows a sectional view of the filter tube of FIG. 6;

FIG. 8 shows a close-up sectional view of the filter tube of FIGS. 6 and 7;

FIG. 9 shows a schematic of a VOC exhaust treatment system of the semiconductor FAB, in accordance with some embodiments; and

FIG. 10 shows a schematic of a catalytic filtration system of the VOC exhaust treatment system of FIG. 9, in accordance with some embodiments.

### DETAILED DESCRIPTION

The following disclosure provides several different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed.

Further, spatially relative terms, such as “beneath,” “below,” “lower,” “above,” “upper” and the like, may be used herein for ease of description to describe one element or feature's relationship to other element(s) or feature(s) as illustrated in the figures. The spatially relative terms are intended to encompass different orientations of the device in use or operation in addition to the orientation illustrated in the figures. The apparatus may be otherwise oriented (rotated 90 degrees or at other orientations) and the spatially relative descriptors used herein may likewise be interpreted accordingly.

Technological advancement has improved the quality of life for a large portion of the global population. However, one of the costs of technological advancement is pollution, such as air and water pollution. Many industrial processes generate air pollutants that are deleterious to humans and the environment. Examples of such industrial processes include fossil fuel power plants, manufacturing facilities, mining operations, and vehicles with internal combustion engines. Some of the air pollutants these processes generate include volatile organic compounds (VOCs), nitrogen oxides, hydrocarbons, particulate matter, carbon monoxide, and ammonia. At least some abatement measures are provided herein that inhibit the impact of pollutants from industrial processes.

The type of abatement measure that is utilized depends on the type of pollutant that is being generated. In many industrial facilities, different types of processes are performed that produce different pollutants that need to be abated differently. One such type of industrial facility is a semiconductor fabrication facility or FAB. The abatement arrangements, apparatus, devices, methods, etc. disclosed herein are particularly suited for use in FABs, such as with regard to VOCs, but may be used in other industrial facilities as well.

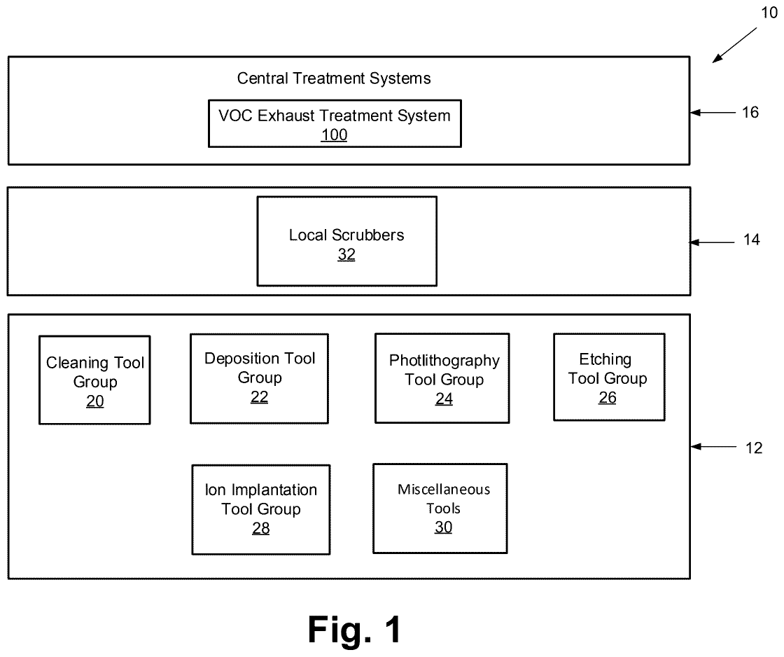

FIG. 1 shows a schematic view of a semiconductor fabrication facility (FAB) 10, in accordance with some embodiments. The semiconductor FAB 10 may include a clean room 12, one or more local facilities 14, and one or more central facilities 16. The clean room 12 includes tools configured to, for example, perform various processes for fabricating integrated circuits on semiconductor wafers. The tools for performing processes may be arranged in groups. For example, a cleaning tool group 20 may be used to perform various cleaning processes, one of which may be a preliminary cleaning process in which the semiconductor wafers are rinsed with deionized water to wash away loose particles and surface contaminants. The semiconductor wafers may then be soaked in organic solvents, such as acetone (C₃H₆O) or isopropyl alcohol (C₃H₈O), to dissolve and remove organic residues, such as oils and grease. Thereafter, other cleaning processes may be performed, such as ultrasonic cleaning and chemical cleaning in which the semiconductor wafers are soaked in chemicals, such as hydrogen peroxide (H2O2), ammonium hydroxide (NH4O4), hydrochloric acid (HCl), and sulfuric acid (H2SO4). After cleaning, the semiconductor wafers may be dried, such as by using an isopropyl alcohol vapor.

A deposition tool group 22 may be used to deposit and/or otherwise form thin layers of different materials on surfaces of cleaned semiconductor wafers. The layers may include, inter alia, conductive metal layers, insulating layers, and semiconductor layers. The formation of the layers may be performed using techniques, such as chemical vapor deposition (CVD) and physical vapor deposition (PVD). Examples of CVD include plasma enhanced chemical vapor deposition (PECVD), low pressure chemical vapor deposition (LPCVD), and atmospheric pressure chemical vapor deposition (APCVD). Examples of PVD include sputtering and vacuum evaporation.

A photolithography tool group 24 may be used to performed photolithography on semiconductor wafers having layers formed thereon. In photolithography, the semiconductor wafers are coated with a light-sensitive coating or photoresist and then are exposed to deep ultraviolet (DUV) or extreme ultraviolet (EUV) light through a mask containing a desired pattern. The photoresist that is exposed to the light through the mask is chemically altered or degraded, which facilitates subsequent removal thereof in a removal process, such as an etching process. An etching tool group 26 may be used to perform an etching process in which degraded photoresist is removed using at least one of a wet chemical process or a dry plasma process. The removal of the degraded photoresist exposes the desired pattern.

Once desired patterns are formed in the semiconductor wafers, ion implantation tools 28 may be used to dope the semiconductor wafers by ion implantation to create desired n-type and/or p-type semiconductor regions. Ion implantation is performed by accelerating ions (e.g., of dopants) to high energies and then directing them onto the surfaces of the semiconductor wafers. The ions penetrate the semiconductor wafers and create concentrations of impurities (e.g., dopants) at specific locations.

Miscellaneous tools 30 may be used to perform other processes, such as metallization, passivation, packaging, etc. In at least some metallization processes electrical connections are formed between different components on a semiconductor wafer. Metallization may be performed using CVD or PVD. In at least some passivation processes, a thin protective layer of insulating material, such as silicon dioxide (SiO2), silicon nitride (Si3N4), polyimide, etc. is formed (e.g., deposited) on the surfaces of the semiconductor wafers, such as by CVD. In at least some packaging processes dies may be cut from the semiconductor wafers and attached to substrates or lead frames and the electrical contacts of the dies connected to package leads. The dies and their interconnections may be sealed in protective material, which may be polymeric, ceramic, etc.

The above-described processes in the semiconductor FAB 10 may produce various types of air pollutants, such as volatile organic compounds (VOCs), acid/alkaline gases, toxic gases, and combustible gases. The air pollutants emitted from the different processes may be categorized by type of air pollutant and, based on this categorization, sent to local scrubbers (LSCs) 32 each of which is specially constructed for a particular type of air pollutant. The LSCs 32 abate the air pollutants using different techniques, which may include a burn-wet technique, a plasma-wet technique, a wet scrubber technique, a dry-absorption technique, a condensation technique, and/or other types of techniques. After the air pollutants are treated by the LSC's, exhaust air from the LSC's may still contain low concentrations of inorganic acid gases, alkaline gases, and VOC's. Each of these types of gases may be separated from the other constituents of the exhaust gases and then combined to form combined streams of VOC exhaust air, acid exhaust air, and alkaline exhaust air. The combined exhaust air streams may be introduced into central treatment systems, respectively. For example, combined VOC exhaust air may be introduced into a central VOC exhaust treatment system, combined acid exhaust air may be introduced into a central acid exhaust treatment system, and combined alkaline exhaust air may be introduced into a central alkaline exhaust treatment system for further treatment. The combined VOC exhaust air may comprise gases, such as isopropanol (isopropyl alcohol), n-butyl acetate, cyclohexanone, and xylene ethyl lactate.

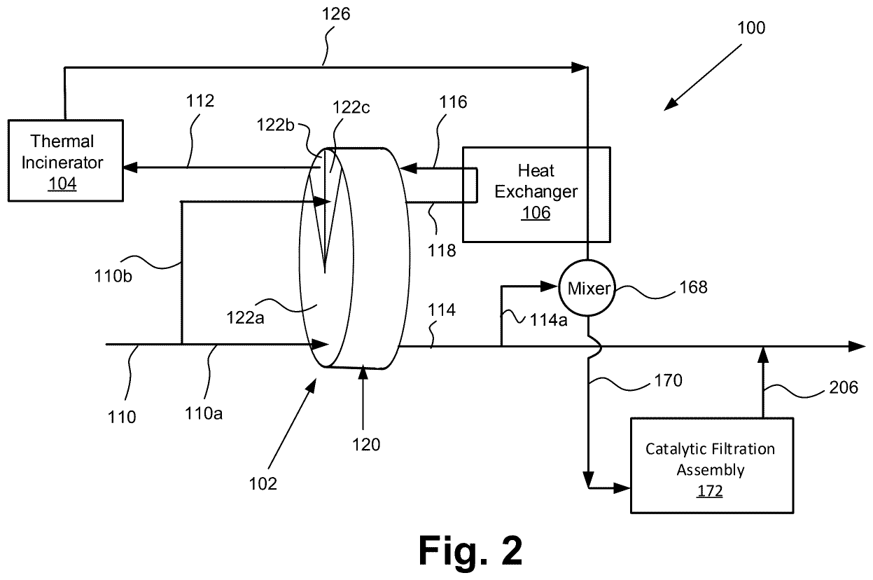

FIG. 2 illustrates a VOC exhaust treatment system 100 in accordance with some embodiments. In some embodiments, the VOC exhaust treatment system 100 may be located in a central facility 16 and may treat the combined VOC exhaust air from the LSCs 32. In some embodiments, the VOC exhaust treatment system 100 may be located in a local facility 14 and may be dedicated to treating local VOC exhaust air from one or more tool groups in the clean room 12, such as the cleaning tool group 20 and/or the deposition tool group 22. Combined VOC exhaust air and local VOC exhaust air are generically referred to below simply as VOC exhaust air.

The VOC exhaust treatment system 100 may include a rotary concentrator 102, a thermal incinerator 104, a heat exchanger 106, and a catalytic filtration system 172, according to some embodiments. The VOC exhaust air may be fed to the rotary concentrator 102 through an inlet line 110. Although not shown, a fan may be connected into the inlet line 110 to move the VOC exhaust air through the rotary concentrator 102. The rotary concentrator 102 is operable to create concentrated VOC air from the VOC exhaust air. In some embodiments, the concentrated VOC air may have a volumetric flow that is from about 2% to about 15% of the VOC exhaust air and may have a VOC concentration that is from about 4 times to about 12 times higher than the VOC concentration of the VOC exhaust air. The concentrated VOC air is fed through line 112 to the thermal incinerator 104 for combustion.

The rotary concentrator 102 may include a rotary wheel 120 that contains adsorbent material and is rotatable through, for example, three zones, such as an adsorption zone 122a, a regeneration or desorption zone 122b, and a cooling zone 122c. In some embodiments, the adsorption zone 122a may comprise about 300° of the angular travel of the rotary wheel 120, while the desorption zone 122b and the cooling zone 122c may each comprise about 30° of the angular travel of the rotary wheel 120. As the rotary wheel 120 rotates, a portion of the adsorbent material may move through the adsorption zone 22a, then may move through the desorption zone 122b, then may move through the cooling zone 122c, and then may move again through the adsorption zone 122a, and so on, for as long the rotary wheel 120 continues to rotate. Thus, at any given point in the rotation of the rotary wheel 120, a portion of the adsorbent material may be disposed in the adsorption zone 122a, while another portion of the adsorbent material may be disposed in the desorption zone 122b, and still another portion of the adsorbent material may be disposed in the cooling zone 122c.

In the adsorption zone 122a, VOC exhaust air from the main inlet line 110a may be passed through the adsorbent material at near ambient temperature, which results in the capture of VOCs on the adsorbent material and discharge of treated air through exit line 114. In the desorption zone 122b, heated air from line 116 may be passed through the adsorbent material containing the captured VOCs from a direction opposite to the flow of the VOC exhaust air. The heated air heats the adsorbent material and causes the captured VOCs to be desorbed into the heated air, thereby forming the concentrated VOC air which exits the rotary concentrator 102 through the line 112. The heated air may have a temperature in a range of from about 220-240° C. to desorb VOCs with high boiling points. The heated air may be obtained from the heat exchanger 106, as described more fully below. In the cooling zone 122c, the VOC exhaust air from the inlet line 110b (at ambient temperature) may be passed through the heated adsorbent material to cool the adsorbent material. In some embodiments, the VOC exhaust air diverted to the inlet line 110b may comprise about 2 to about 15% of the total VOC exhaust air. The VOC exhaust air may exit the rotary wheel 120 in the cooling zone 122c as feed air, which may be fed through line 118 to the heat exchanger 106. Incinerator exhaust air from the thermal incinerator 104 may be supplied to the heat exchanger 106 through line 126. Inside the heat exchanger 106, heat from the incinerator exhaust air may be transferred to the feed air, thereby forming the heated air that is supplied from the line 116 to the adsorbent in the desorption zone 122b. This heat transfer may also form partially cooled incinerator exhaust air, which may be fed to a mixer 168.

The adsorbent material in the rotary wheel 120 may be activated carbon, zeolite, a macroreticular resin, or other type of adsorbent. In some embodiments, the rotary wheel 120 may be a honeycomb zeolite rotor (HZR) in which the absorbent comprises a honeycomb zeolite formed from rolls of inorganic fiber paper arranged in a honeycomb structure. The inorganic fiber paper may be formed from ceramic or glass fibers and may be coated with hydrophilic or hydrophobic zeolites. Examples of zeolites that may be used include FAU, MFI, DDR, MOR, LTA, BEA, and CHA zeolites.

In some embodiments, a second rotary concentrator 102 may be connected in series with the (first) rotary concentrator 102 to further reduce the VOCs in the discharged treated air.

The thermal incinerator 104 burns the concentrated VOC air from the rotary concentrator 102 to transform the VOCs primarily to carbon dioxide (CO₂) and water. However, other less desirable byproducts may also be produced, such as nitrogen oxide (NO) and nitrogen dioxide (NO₂), which may be collectively referred to as NOx. Particulate matter (e.g., silica dust) may also be produced. The thermal incinerator 104 may be configured to incinerate or burn the concentrated VOC air flow so as to have exhaust air with a low NOx content. In some embodiments, the thermal incinerator 104 may utilize staged combustion in which a fuel-rich (oxygen deficient) high temperature combustion stage chemically converts NOx precursors to molecular nitrogen and is accompanied by a lower temperature, fuel lean combustion stage to complete the combustion. The two stages may be performed sequentially in physically separated regions of a combustion chamber or together in one single region of a combustion chamber.

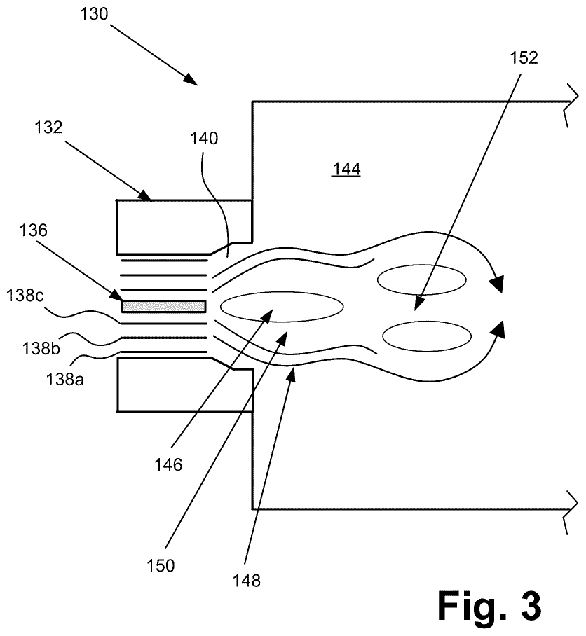

In the case where the two stages take place in one single region of a combustion chamber, the thermal incinerator 104 may comprise one or more radially stratified flame core burners 130, one of which is shown in FIG. 3. The burner 130 may have a burner head 132 with a central fuel gun 136 surrounded by three annular air nozzles 138a,b,c arranged concentrically. The concentrated VOC air may be divided into streams of concentrated VOC air, which are fed to the central fuel gun 136 and the air nozzles 138a,b,c, respectively. Air may also be mixed with the concentrated VOC air to form combustion air. A fuel, such as natural gas, together with a stream of combustion air may be mixed to form a combustible core fuel/air flow, which is ejected from the central fuel gun 136 into a throat 140 of the burner head 132, which opens into a combustion chamber 144. Inside the throat 140, the combustible core fuel/air flow is combusted to form a burning fuel-rich core 146 that extends into the combustion chamber 144. The other streams of combustion air may be passed through swirlers and directed into the air nozzles 138a,b,c, respectively. The swirlers create toroidal flows of combustion air which enter the throat 140 and thence the combustion chamber 144 and swirl around the burning fuel-rich core 146, thereby forming a flame envelope 148 that radially stratifies the burning fuel-rich core 146 and combustion air flows (e.g., suppressing the mixing of the burning fuel-rich core 146 with the combustion air flows). This stratification may be controlled by separately controlling the tangential swirl of the combustion air flows. The stratification occurs close to the throat 140 exit and may create a first combustion zone 150. A second combustion zone 152 may be disposed downstream from the first combustion zone 150.

In the first combustion zone 150, combustion is fuel-rich and occurs at high temperatures, which inhibits the production of NOx by limiting available oxygen and also destroys NOx that may enter the first combustion zone 150 from the second combustion zone 152. Combustion products of the first combustion zone 150 gradually mix with the rest of the combustion air in the second combustion zone 152 and are combusted to create a combustion environment that is fuel-lean and rich with combustion products with low oxygen content. Combustion proceeds to completion in the second combustion zone 152.

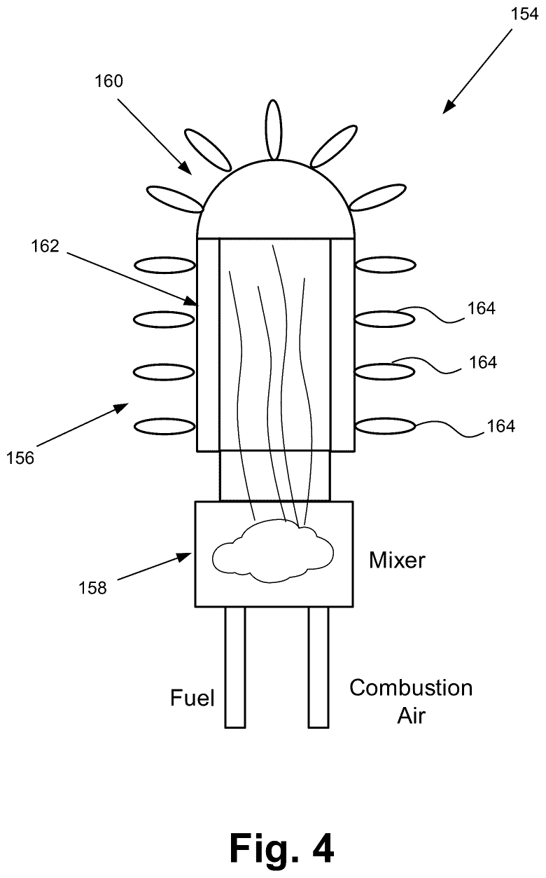

In some embodiments, a thermal incinerator 154 may be used instead of the thermal incinerator 104. Referring now to FIG. 4, the thermal incinerator 154 may include one or more burners 156 that have surface-stabilized combustion in which fuel, such as natural gas, and combustion air (e.g., comprising the concentrated VOC air from the rotary concentrator(s) 102) may be premixed in a mixer 158 fluidly connected to a burner head 160 having a relatively large outer surface 162. The burner head 160 may be hollow and comprise a porous ceramic formed from ceramic fibers and inorganic adhesive that has been sintered. The fuel-combustion air mixture may be passed through walls of the porous burner head 160 and ignited on the outer surfaces 162 thereof to form a large number of flames 164. In this manner, the premixing of the fuel and combustion air is separated from the combustion by the burner head 160. The fuel-combustion air mixture may be lean (e.g., more excess air) to lower the adiabatic flame temperature, which promotes low NOx emissions. Such lean operation can cause combustion instability, with high carbon monoxide emissions; however, the relatively large outer surfaces 162 of the burner head 160 with many points of flame attachment keeps the combustion stable.

After passing through the heat exchanger 106, partially-cooled incinerator exhaust air from the thermal incinerator 104 (or thermal incinerator 154) may be combined in a mixer 168 with a portion of the treated air exiting the rotary concentrator(s) 102 through branch exit line 114a to form a cooled incinerator exhaust air, which may have a temperature of about 200° C. to about 230° C., usually about 210° C. The mixer 168 may utilize a venturi throat to mix the partially cooled incinerator exhaust air and the portion of the treated air, which may have a temperature of from about 28° C. to about 32° C., usually about 29.8° C. The temperature of the cooled incinerator exhaust air depends on the amount of incinerator exhaust air exiting the thermal incinerator 104, which depends on the portion of VOC exhaust air diverted to the inlet line 110b for desorbing the adsorbent to form the concentrated VOC air. The temperature of the cooled incinerator exhaust air also depends on the portion of the treated air exiting the rotary concentrator(s) 102 that is diverted through branch exit line 114a to the mixer 168 to cool the partially-cooled incinerator exhaust air. The portion of the VOC exhaust air diverted to the inlet line 110b and the portion of the treated air that is mixed with the partially-cooled incinerator exhaust air may be selected to provide the cooled incinerator exhaust air with a temperature of from 140° C. to about 180° C., usually about 160° C. In some embodiments, the portion of the VOC exhaust air diverted to the inlet line 110b may be from about 2% to about 5%, usually about 3%, while the portion of the treated air that is mixed with the partially-cooled incinerator exhaust air may also be from about 2% to about 5%, usually about 3%.

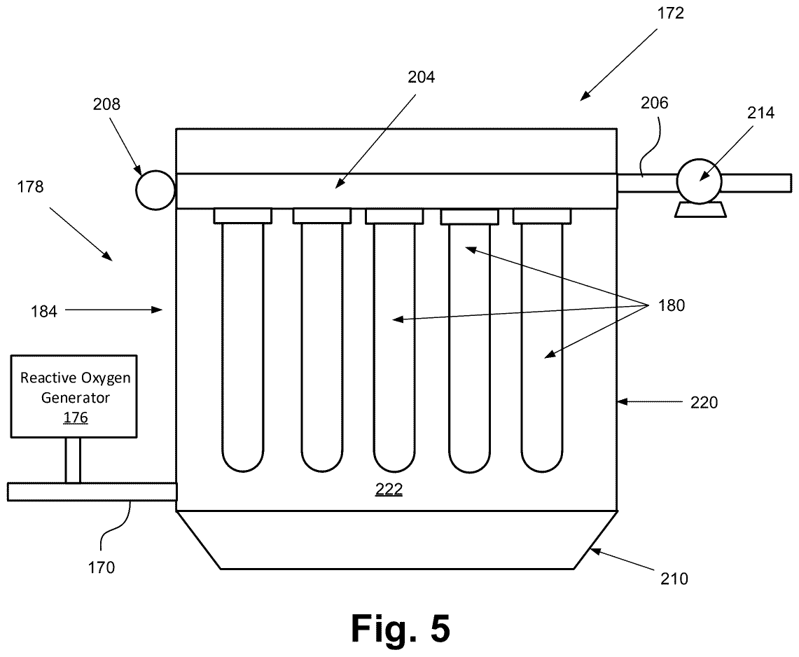

Referring now to FIG. 2 and FIG. 5, the cooled incinerator exhaust air from the mixer 168 may be transported through line 170 to the catalytic filtration system 172, where the cooled incinerator exhaust air may be treated to remove NOx and particulate matter. The catalytic filtration system 172 may include a reactive oxygen generator 176 and a filtration assembly 178. The reactive oxygen generator 176 is operable to inject ozone (O₃) and/or reactive oxygen species (ROS) into the cooled incinerator exhaust air. ROS are molecules capable of independent existence, containing at least one oxygen atom and one or more unpaired electrons. ROS may include atomic oxygen (O*), hydroperoxide (O₂H), superoxide (O₂⁻), hydroxyl radical (HO*) and singlet oxygen (¹O₂), hydrogen peroxide (H₂O₂), etc. The reactive oxygen generator 176 may have an injector connected into the line 170 proximate to an inlet of the filtration assembly 178.

The reactive oxygen generator 176 may be a cold plasma generator or an ozone generator. A cold plasma generator generates ROS and may also generate ozone, while an ozone generator primarily generates ozone. Both an ozone generator and a plasma generator may use oxygen, ambient air, or other oxygen-containing gas as a feedstock gas. In some embodiments, oxygen is used as the feedstock gas.

An ozone generator may produce ozone by using corona discharge or ultraviolet (UV) light. In an ozone generator using corona discharge, the feedstock gas may be fed through a high voltage metallic grid, which splits apart O₂ molecules into single atoms. These atoms are then allowed to combine with other O₂ molecules to form ozone. In a UV light ozone generator, feedstock gas may be fed through a chamber where it is exposed to ultraviolet light, which splits apart O₂ molecules into single atoms. Once again, these atoms are then allowed to combine with other O₂ molecules to form ozone.

A cold plasma generator is similar to an ozone generator using corona discharge. A cold plasma generator may have a pair of electrodes separated by a space through which the feed stock gas may be fed or in which the feed stock gas is held. One or more thin dielectric layers or structures may be disposed between the electrodes. In some embodiments, each of the electrodes may be coated with or disposed adjacent to a dielectric layer. A power supply is connected to the electrodes to provide power to the electrodes. The voltage and frequency of the supplied power, the size of the space containing the feedstock gas, and the dimensions and composition of the dielectric may all be selected to transform the feedstock gas into a low temperature plasma containing ROC. Some ozone may also be produced.

The reactions that may occur in the reactive oxygen generator 176 include the following:

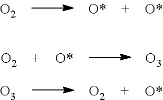

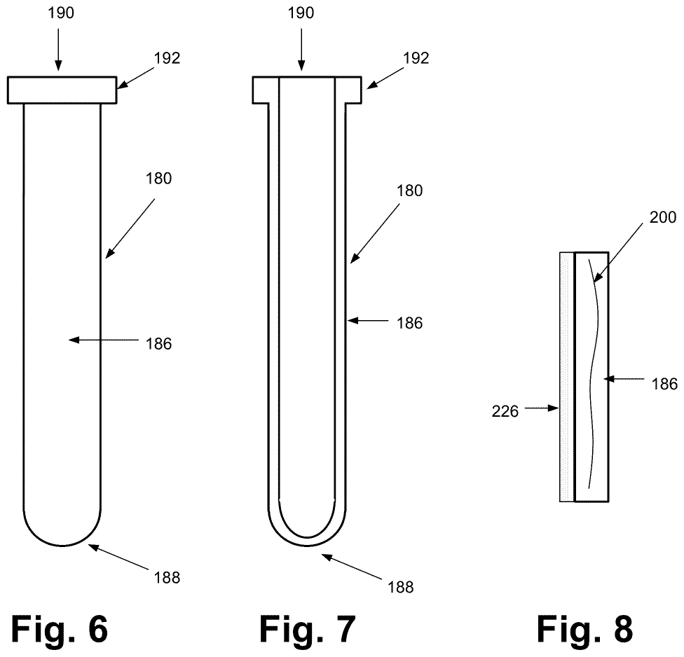

The injection of ozone and/or ROS from the reactive oxygen generator 176 into the cooled incinerator exhaust air creates oxygenated incinerator exhaust air, which may be fed to the filtration assembly 178 through the line 170. Referring now also to FIGS. 6-8, the filtration assembly 178 may include a plurality of filter tubes 180 mounted in a support structure 184. Each filter tube 180 may have a cylindrical side wall 186, a closed end 188, and an open end 190 with a collar 192. The filter tubes 180 may be formed from a porous ceramic material, which may comprise ceramic fibers coated with an inorganic adhesive. Examples of the ceramic fibers that may be used include alumina fibers, silica fibers, and alumina-silica fibers. The inorganic adhesive may comprise particles, such as oxides, nitrides, and/or carbides. Oxides that may be used include silica, alumina, mullite, spinel, zirconia, and magnesia; nitrides that may be used include boron nitride; and carbides that may be used include boron carbide. The inorganic adhesive may further comprise a binder, such as fumed silica, sodium silicate, potassium silicate, magnesium silicate, calcium silicate, and magnesium aluminum silicate. The inorganic binder may be applied to the ceramic fibers as a liquid coating, such as an aqueous coating.

The filter tubes 180 may be formed by winding the ceramic fibers coated with the inorganic adhesive into nascent tubes and then heating the nascent tubes to remove volatiles. Thereafter, the nascent tubes may be fired at a high temperature, such as greater than 1300° C. In some embodiments, the selection of components (e.g., ceramic fibers and inorganic adhesive) and the conditions of firing the nascent tubes may form cordierite, mullite, or cordierite-mullite (e.g., the filter tubes 180 may comprise cordierite, mullite, or cordierite-mullite). After the nascent filter tubes are fired and allowed to cool, the collars 192 may be secured thereto, respectively, and an oxidation catalyst 200 may be applied to the interiors of the nascent filter tubes, respectively.

In some embodiments, the filter tubes 180 may be formed such that the porosity of the side wall 186 at its outer surface is less than the porosity of the side wall 186 radially inward therefrom. In this manner, particulate matter 226 may be more likely to be trapped on the exterior surfaces of the filter tubes 180 as the particulate matter 226 is drawn through the filter tubes 180.

The oxidation catalyst 200 may be applied to the nascent filter tubes in the form of a liquid coating composition, which may be a dispersion of metal particles in water, such as a suspension or slurry of manganese in water. In some embodiments, the liquid coating composition may comprise manganese and iron in a 2:1 molar ratio. The manganese and iron, together with nitric acid (HNO₃), may be mixed together in purified water to form a slurry. The liquid coating composition may be applied to the interiors of each of the nascent filter tubes through its open end such that the oxidation catalyst is drawn into the pores of the side walls 186.

Inside the support structure 184, the collars of the filter tubes 180 may be releasably securely connected to a manifold 204 that is connected at one end to outlet line 206 for conveying filtered clean air from the filter tubes 180 to the outside environment, such as through an exhaust stack. The manifold 204 may also be selectively connected at another end to a compressed air source 208 for cleaning the filter tubes 180, as will be described more fully below. In this regard, a hopper 210 may be disposed below the filter tubes 180 for collecting particulate matter 226 from the filter tubes 180 during cleaning. A fan 214 may be mounted in the outlet line 206 to draw air through the filter tubes 180 and into the outlet line 206, which may be connected to the exit line 114. The exit line 114, in turn, may be connected to an exhaust structure, such as a stack, or to further processing equipment.

The support structure 184 may include a housing 220 that forms a plenum 222 within which the filter tubes 180 are disposed. Oxygenated incinerator exhaust air may enter the plenum 222 through an inlet connected to line 170. The inlet to the plenum 222 may be located below the filter tubes 180 and above the hopper 210. The oxygenated incinerator exhaust air may be drawn through the side walls 186 of the filter tubes 180, such as by the fan 214, and may be drawn upwardly through the interiors of the filter tubes 180, exiting through their open ends 190, into the manifold 204. As the oxygenated incinerator exhaust air passes through the side walls 186, particulate matter 226 may be trapped in the pores of the side walls 186 in their outer surfaces. The partially treated air may continue through the side walls 186 and encounter the oxidation catalyst 200, which catalyzes the reaction of the NOx with the ozone and/or the ROC in the air, thereby forming nitrogen oxides with higher oxygenation of the type NₓO_{y} (e.g., where x and y are each 2 or greater), such as dinitrogen dioxide (N₂O₂), dinitrogen trioxide (N₂O₃), dinitrogen tetroxide (N₂O₄), dinitrogen pentoxide (N₂O₅), and mixtures thereof. A mechanism for forming NₓO_{y} is as follows:

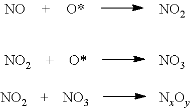

The formation of nitrogen oxides with higher oxygenation further reduces the NOx such that the treated air exiting the filter tubes 180 has a very low NOx level, as well as a low particulate level. As described above, the treated air may flow through the manifold 204, into the outlet line 206 and thence to the exit line 114, which may lead to an exhaust structure, or to further processing equipment.

It has been found that oxygenated combustion air entering the catalytic filtration system 172 at a flowrate of 5 liters per minute (LPM) and a temperature of 160° C. will exit the catalytic filtration system 172 with more than 80% of NOx removed, both when the entering combustion air has a high NOx concentration of 100 parts per million (PPM) and a low NOx concentration of 20 PMM. It has also been found that oxygenated combustion air containing silica dust entering the catalytic filtration system 172 at a temperature of 160° C. will exit the catalytic filtration system 172 with an average NOx removal efficiency of greater than 90% and a silica dust removal efficiency of between 90% and 94%, both when the entering combustion air has a high NOx concentration of greater than 100 parts per million (PPM) and a low NOx concentration of about 40 PMM.

The foregoing treatment of the oxygenated incinerator exhaust air by the catalytic filtration system 172 may continue until the particulate matter 226 builds up on the outer surfaces of the side walls 186 of the filter tubes 180 to a predetermined level or for a predetermined period of time, at which point, the treatment may be stopped to permit the cleaning of the filter tubes 180. During the cleaning, the lines 170, 206 may be closed and appropriate vents (not shown) may be opened. Compressed air from the compressed air source 208 may be directed into the manifold 204 and travel into the filter tubes 180 through their open ends 190. Inside the filter tubes 180, the compressed air may pass through the side walls 186 and contact the particulate matter 226 on the outside surfaces thereof, thereby dislodging the particulate matter 226 and causing the particulate matter 226 to fall into the hopper 210. After a sufficient amount of the particulate matter 226 has been removed, the cleaning process may be stopped and the catalytic filtration system 172 may be returned to its normal treatment state.

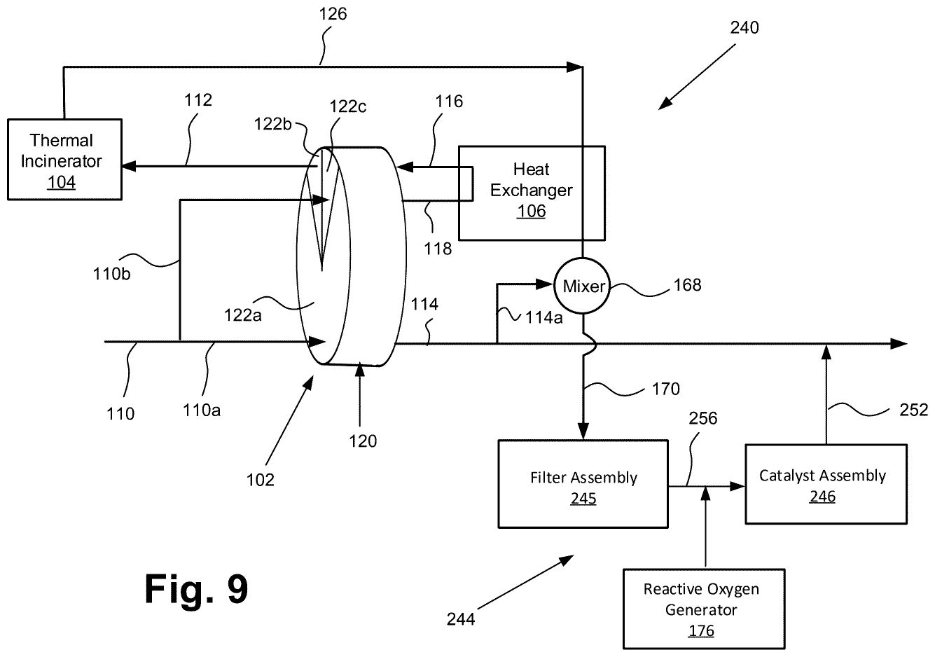

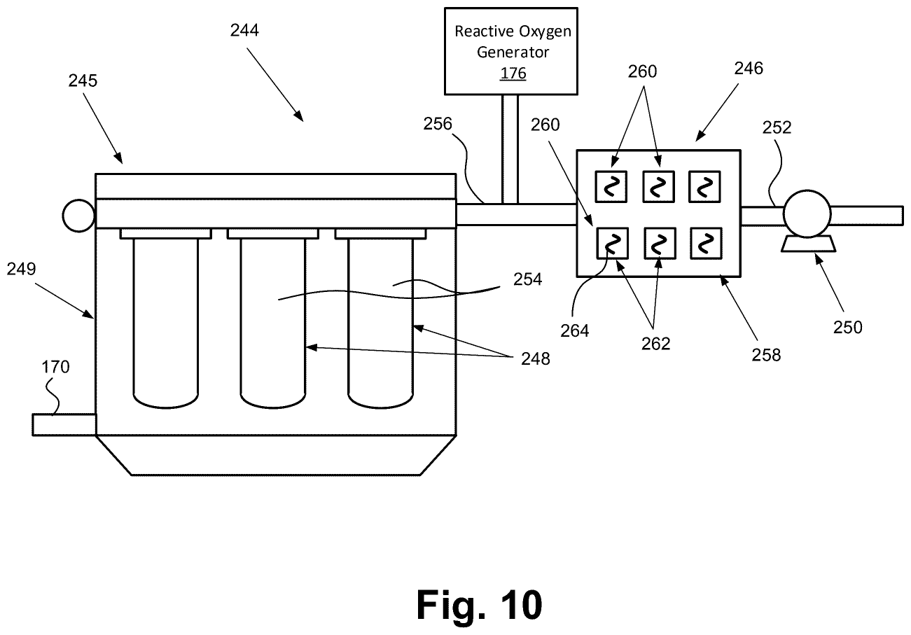

Referring now to FIG. 9, there is shown VOC exhaust treatment system 240, constructed in accordance with some embodiments. The VOC exhaust treatment system 240 has substantially the same construction and operation as the VOC exhaust treatment system 100, except for at least some differences described below. The VOC exhaust treatment system 240 does not have the catalytic filtration system 172. Instead, the VOC exhaust treatment system 240 may have a catalytic filtration system 244, which may include the reactive oxygen generator 176, a filter assembly 245, and a catalyst assembly 246. Air may be drawn through the catalytic filtration system 244 by a fan 250 connected into an outlet line 252, as shown in FIG. 10.

Referring now also to FIG. 10, the filter assembly 245 may be separate from the catalyst assembly 246. The filter assembly 245 may include one or more filters 248, each of which includes one or more layers of a filter media 254 supported by a frame, cage or other type of support. The filter(s) 248 may have any suitable configuration, such as a panel, a bag, a cylinder (cartridge), or a multi-pocket arrangement. The filter(s) 248 is/are constructed to withstand high temperatures, such as greater than 180° C. The filter media 254 may comprise fibrous material which is woven or non-woven and which may be polymeric, glass, ceramic, or metal. For example, the filter media 254 may be formed from fabric formed from: woven fiberglass, felt formed from polyphenylene sulfide (PPS), woven or unwoven aramid fibers, or polyimide nanofibers. In some embodiments, the filter assembly 245 may comprise multiple filters 248 in the form of bags mounted in a housing 249. In such embodiments, the filters 248 may have closed ends and open ends mounted to a manifold, similar to the filter tubes 180; and the housing 249 may have a configuration and operation similar to the support structure 184. In some embodiments, the filter assembly 245 may comprise multiple filters 248 arranged for multi-stage filtration.

The catalyst assembly 246 may be connected to the filter assembly 245 by a line 256 and may include a housing 258 enclosing one or more catalyst units 260 configured as blocks, rods, panels, or other shapes. Each catalyst unit 260 may have a substrate 262 infused with an oxidation catalyst 264. The substrate 262 may be formed from a porous material, such as a porous ceramic. In some embodiments, the porous material may be the same as that used to form the filter tubes 180 (e.g., ceramic fibers coated with an inorganic adhesive that is sintered, as described more fully above). In some embodiments, the porous material may be porous blocks of cordierite. The oxidation catalyst 264 may have the same composition as the oxidation catalyst 200 described above. In addition, the oxidation catalyst 264 may also be applied to the substrate 262 in the form of a liquid coating composition, which may be a dispersion of metal particles in water, such as a suspension or slurry of manganese in water. In some embodiments, the liquid coating composition may comprise manganese and iron in a 2:1 molar ratio.

The catalytic filtration system 244 may receive the cooled incinerator exhaust air from the mixer 168 through line 170 and may treat the cooled incinerator exhaust air to remove NOx and particulate matter. More specifically, the cooled incinerator exhaust air first may first pass through the filter assembly 245, thereby removing particulate matter to form filtered incinerator exhaust air. Thereafter, ozone and/or ROS from the reactive oxygen generator 176 may be injected into the filtered incinerator exhaust air in the line 256 to create oxygenated and filtered incinerator exhaust air, which may then be fed to the catalyst assembly 246. Inside the catalyst assembly 246, the oxygenated and filtered incinerator exhaust air may pass over and through the catalyst unit(s) 260, thereby contacting the oxidation catalyst 264, which catalyzes the reaction of the NOx with the ozone and/or the ROC in the air, thereby forming nitrogen oxides with higher oxygenation of the type NₓO_{y}.

The formation of nitrogen oxides with higher oxygenation further reduces the NOx such that the treated air exiting the catalyst assembly 246 has a very low NOx level, as well as a low particulate level. From the catalyst assembly 246, the treated air may flow through the outlet line 252 to the exit line 114 and then to an exhaust structure, or to further processing equipment.

It should be appreciated that the VOC exhaust treatment system 100 and the VOC exhaust treatment system 240 may include additional equipment and/or devices that are not shown or described above for purposes of succinctness and clarity. For example, additional fans may be provided for moving air through the lines in the systems and valves may be provided for opening and closing lines and diverting air flows.

According to some embodiments, a system is provided for treating air containing volatile organic compounds (VOCs). The system includes a concentrator configured to remove VOCs from the air to form treated air and concentrated VOC air, a thermal incinerator connected to the concentrator to receive the concentrated VOC air, the thermal incinerator being configured to mix the concentrated VOC air with fuel to form a fuel/air mixture and to combust the fuel/air mixture to form incinerator exhaust air containing at least one of nitrogen oxide or nitrogen dioxide (NOx), a mixer connected to the thermal incinerator to receive the incinerator exhaust air and connected to the concentrator to receive a portion of the treated air, the mixer being configured to mix the portion of the treated air with the incinerator exhaust air to cool the incinerator exhaust air to form cooled incinerator exhaust air, and a catalytic filtration system connected to the mixer to receive the cooled incinerator exhaust air, the catalytic filtration system being configured to remove particulate matter from the cooled incinerator exhaust air and to reduce NOx in the cooled incinerator exhaust air, the catalytic filtration system including a filtration assembly comprising one or more filters configured to remove the particulate matter, a reactive oxygen generator configured to generate at least one of ozone or reactive oxygen species (ROS) for injection into the cooled incinerator exhaust air to generate reacted cooled incinerator exhaust air, and one or more catalysts for contact with the reacted cooled incinerator exhaust air, the one or more catalysts being formulated to convert NOx to nitrogen oxides of the formula NₓO_{y}, where x and y are each 2 or greater.

According to some embodiments, a system is provided for treating air containing volatile organic compounds (VOCs). The system includes a concentrator configured to remove VOCs from the air to form treated air and concentrated VOC air, a thermal incinerator connected to the concentrator to receive the concentrated VOC air, the thermal incinerator being configured to mix the concentrated VOC air with fuel to form a fuel/air mixture and to combust the fuel/air mixture to form incinerator exhaust air containing at least one of nitrogen oxide or nitrogen dioxide (NOx), a mixer connected to the thermal incinerator to receive the incinerator exhaust air and connected to the concentrator to receive a portion of the treated air, the mixer being configured to mix the portion of the treated air with the incinerator exhaust air to cool the incinerator exhaust air to form cooled incinerator exhaust air, and a catalytic filtration system connected to the mixer to receive the cooled incinerator exhaust air, the catalytic filtration system being configured to remove particulate matter from the cooled incinerator exhaust air and to reduce NOx in the cooled incinerator exhaust air, wherein the concentrator includes a rotary wheel containing adsorbent material, the rotary wheel being rotatable to move the adsorbent material through a sequence comprising an adsorption zone, then a desorption zone, and then a cooling zone, wherein the concentrator is configured such that when the adsorbent material is in the adsorption zone, the air is passed through the adsorbent material, thereby causing VOCs to be captured by the adsorbent material and the treated air to exit the adsorbent material, wherein the concentrator is configured such that when the adsorbent material is in the desorption zone, heated air is passed through the adsorbent material, thereby heating the adsorbent material and causing captured VOCs from the adsorbent material to be desorbed into the heated air, thereby forming the concentrated VOC air, and wherein the concentrator is configured such that when the adsorbent material is in the cooling zone, the air is passed through the adsorbent material, thereby cooling the adsorbent material and forming feed air.

According to some embodiments, a method is provided for treating air containing volatile organic compounds (VOCs). The method includes removing VOCs from the air to form treated air and concentrated VOC air, mixing the concentrated VOC air with fuel to form a fuel/air mixture, combusting the fuel/air mixture to form incinerator exhaust air containing at least one of nitrogen oxide or nitrogen dioxide (NOx), cooling the incinerator exhaust air to form cooled incinerator exhaust air, generating at least one of ozone or reactive oxygen species (ROS) for injection into the cooled incinerator exhaust air to generate reacted cooled incinerator exhaust air, removing particulate matter from the reacted cooled incinerator exhaust air, and converting NOx in the reacted cooled incinerator exhaust air into nitrogen oxides of the formula NₓO_{y}, where x and y are each 2 or greater.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for treating air containing volatile organic compounds (VOCs), the system comprising:
a concentrator configured to remove VOCs from the air to form treated air and concentrated VOC air;
a thermal incinerator connected to the concentrator to receive the concentrated VOC air, the thermal incinerator being configured to mix the concentrated VOC air with fuel to form a fuel/air mixture and to combust the fuel/air mixture to form incinerator exhaust air containing at least one of nitrogen oxide or nitrogen dioxide (NOx);
a mixer connected to the thermal incinerator to receive the incinerator exhaust air and connected to the concentrator to receive a portion of the treated air, the mixer being configured to mix the portion of the treated air with the incinerator exhaust air to cool the incinerator exhaust air to form cooled incinerator exhaust air; and
a catalytic filtration system connected to the mixer to receive the cooled incinerator exhaust air, the catalytic filtration system being configured to remove particulate matter from the cooled incinerator exhaust air and to reduce NOx in the cooled incinerator exhaust air, the catalytic filtration system comprising:
a filtration assembly comprising one or more filters configured to remove the particulate matter;
a reactive oxygen generator configured to generate at least one of ozone or reactive oxygen species (ROS) for injection into the cooled incinerator exhaust air to generate reacted cooled incinerator exhaust air; and
one or more catalysts for contact with the reacted cooled incinerator exhaust air, the one or more catalysts being formulated to convert NOx to nitrogen oxides of the formula NₓO_{y}, where x and y are each 2 or greater.

2. The system of claim 1, wherein at least one of the one or more filters comprises at least one of the one or more catalysts.

3. The system of claim 1, wherein at least one of the one or more filters comprises ceramic material having pores containing at least one of the one or more catalysts.

4. The system of claim 1, wherein at least one of the one or more catalysts comprises at least one of manganese or iron.

5. The system of claim 1, wherein at least one of the one or more filters comprises a web of fibrous material.

6. The system of claim 1, wherein the concentrator comprises a rotary wheel containing adsorbent material, the rotary wheel being rotatable to move the adsorbent material through a sequence comprising an adsorption zone, then a desorption zone, and then a cooling zone;
wherein the concentrator is configured such that when the adsorbent material is in the adsorption zone, the air is passed through the adsorbent material, thereby causing VOCs to be captured by the adsorbent material and the treated air to exit the adsorbent material;
wherein the concentrator is configured such that when the adsorbent material is in the desorption zone, heated air is passed through the adsorbent material, thereby heating the adsorbent material and causing captured VOCs from the adsorbent material to be desorbed into the heated air, thereby forming the concentrated VOC air; and
wherein the concentrator is configured such that when the adsorbent material is in the cooling zone, the air is passed through the adsorbent material, thereby cooling the adsorbent material and forming feed air.

7. The system of claim 6, comprising a heat exchanger that connects the mixer to the thermal incinerator, the heat exchanger being connected to the concentrator to receive the feed air from the adsorbent material in the cooling zone and being connected to the thermal incinerator to receive the incinerator exhaust air, the heat exchanger being configured to transfer heat from the incinerator exhaust air to the feed air, thereby forming partially cooled incinerator exhaust air and the heated air passed through the adsorbent material in the desorption zone;
wherein the heat exchanger is connected to supply the mixer with the partially cooled incinerator exhaust air; and
wherein the mixer is configured to mix the partially cooled incinerator exhaust air with the portion of the treated air to form the cooled incinerator exhaust air.

8. The system of claim 1, wherein the thermal incinerator is configured to perform staged combustion comprising a fuel-rich, oxygen deficient, high temperature combustion stage accompanied by a lower temperature, fuel lean combustion stage.

9. A system for treating air containing volatile organic compounds (VOCs), the system comprising:
a concentrator configured to remove VOCs from the air to form treated air and concentrated VOC air;
a thermal incinerator connected to the concentrator to receive the concentrated VOC air, the thermal incinerator being configured to mix the concentrated VOC air with fuel to form a fuel/air mixture and to combust the fuel/air mixture to form incinerator exhaust air containing at least one of nitrogen oxide or nitrogen dioxide (NOX);
a mixer connected to the thermal incinerator to receive the incinerator exhaust air and connected to the concentrator to receive a portion of the treated air, the mixer being configured to mix the portion of the treated air with the incinerator exhaust air to cool the incinerator exhaust air to form cooled incinerator exhaust air; and
a catalytic filtration system connected to the mixer to receive the cooled incinerator exhaust air, the catalytic filtration system being configured to remove particulate matter from the cooled incinerator exhaust air and to reduce NOx in the cooled incinerator exhaust air, wherein the concentrator comprises:
a rotary wheel containing adsorbent material, the rotary wheel being rotatable to move the adsorbent material through a sequence comprising an adsorption zone, then a desorption zone, and then a cooling zone;
wherein the concentrator is configured such that when the adsorbent material is in the adsorption zone, the air is passed through the adsorbent material, thereby causing VOCs to be captured by the adsorbent material and the treated air to exit the adsorbent material;
wherein the concentrator is configured such that when the adsorbent material is in the desorption zone, heated air is passed through the adsorbent material, thereby heating the adsorbent material and causing captured VOCs from the adsorbent material to be desorbed into the heated air, thereby forming the concentrated VOC air; and
wherein the concentrator is configured such that when the adsorbent material is in the cooling zone, the air is passed through the adsorbent material, thereby cooling the adsorbent material and forming feed air.

10. The system of claim 9, comprising a heat exchanger that connects the mixer to the thermal incinerator, the heat exchanger being connected to the concentrator to receive the feed air from the adsorbent material in the cooling zone and being connected to the thermal incinerator to receive the incinerator exhaust air, the heat exchanger being configured to transfer heat from the incinerator exhaust air to the feed air, thereby forming partially cooled incinerator exhaust air and the heated air passed through the adsorbent material in the desorption zone;
wherein the heat exchanger is connected to supply the mixer with the partially cooled incinerator exhaust air; and
wherein the mixer is configured to mix the partially cooled incinerator exhaust air with the portion of the treated air to form the cooled incinerator exhaust air.

11. The system of claim 9, wherein the catalytic filtration system comprises:
a filtration assembly comprising one or more filters configured to remove the particulate matter;
a reactive oxygen generator configured to generate at least one of ozone or reactive oxygen species (ROS) for injection into the cooled incinerator exhaust air to generate reacted cooled incinerator exhaust air; and
one or more catalysts for contact with the reacted cooled incinerator exhaust air, the one or more catalysts being formulated to convert NOx to nitrogen oxides of the formula NₓO_{y}, where x and y are each 2 or greater.

12. The system of claim 11, wherein at least some of the one or more catalysts are disposed in pores of ceramic material.

13. The system of claim 11, wherein at least one of the one or more filters comprises ceramic material having pores containing at least one of the one or more catalysts.

14. The system of claim 11, wherein at least one of the one or more catalysts comprises at least one of manganese or iron.

15. A method for treating air containing volatile organic compounds (VOCs), the method comprising:
removing VOCs from the air to form treated air and concentrated VOC air;
mixing the concentrated VOC air with fuel to form a fuel/air mixture;
combusting the fuel/air mixture to form incinerator exhaust air containing at least one of nitrogen oxide or nitrogen dioxide (NOx);
cooling the incinerator exhaust air to form cooled incinerator exhaust air;
generating at least one of ozone or reactive oxygen species (ROS) for injection into the cooled incinerator exhaust air to generate reacted cooled incinerator exhaust air;
removing particulate matter from the reacted cooled incinerator exhaust air; and
converting NOx in the reacted cooled incinerator exhaust air into nitrogen oxides of the formula NₓO_{y}, where x and y are each 2 or greater.

16. The method of claim 15, wherein removing the particulate matter comprises using a filter comprising a tube of ceramic material having a side wall, an open end, a closed end, and a hollow interior.

17. The method of claim 16, comprising moving the reacted cooled incinerator exhaust air through the side wall, into the hollow interior, and out the open end.

18. The method of claim 15, wherein removing the particulate matter comprises using a filter comprising a web of fibrous material.

19. The method of claim 15, wherein mixing the concentrated VOC air with fuel to form a fuel/air mixture and combusting the fuel/air mixture to form incinerator exhaust air comprises forming a fuel-rich, oxygen deficient, high temperature combustion stage accompanied by a lower temperature, fuel lean combustion stage.

20. The method of claim 15, wherein cooling the incinerator exhaust air comprises mixing a portion of the treated air with the incinerator exhaust air to cool the incinerator exhaust air to form the cooled incinerator exhaust air.
